(19) United States
(12) Patent Application Publication
(10) Pub. No.: US 2011/0174023 A1
(43) Pub. Date: Jul. 21, 2011

(54) WIRE ROPE CLAMP LOCKABLE NUT SYSTEMS AND METHODS

(76) Inventors: KENNETH H. GEORGE, LANCASTER, CA (US); Joseph Gregorwich, Costa Mesa, CA (US)

(21) Appl. No.: 12/690,262

(22) Filed: Jan. 20, 2010

(51) Int. Cl. E05B 65/00; F16B 39/04

(52) U.S. Cl. 70/19; 411/190

(57) ABSTRACT

A lockable nut comprising a first threaded bore configured for use with a wire rope clamp. The lockable nut comprises a threaded bore for engagement with a u-bolt, for example, and a transverse bore configured to receive a locking shaft, such as a shackle of a lock. As a safety and/or security feature, a pair of lockable nuts may be coupled to a wire rope clamp connected to a wire rope, and when the locking shaft is in place, the wire rope clamp can not be removed from the wire rope.

### FIELD OF THE INVENTION

The invention relates generally to wire rope and more specifically to devices and method to prevent the removal of wire rope once it has been placed in a location.

### BACKGROUND

Wire rope generally consists of several strands twisted together in a helix formation. Each strand is made of metal wires, such as steel. The end of a span of wire rope may be terminated by passing a first portion of the wire rope through a connection point, such as an eyelet, and drawing the first portion along a second portion of the wire rope to form a loop. At least one wire rope clamp is used to create a connection between the first and second portions of the span to affix the wire rope to the connection point. Such terminations may be used, for example, to attach the wire rope to various equipment and structures. In some cases, spans of wire rope are temporarily extended across various locations on a construction site as a safety and/or security measure.

In order to connect two sections of a wire rope together, such as to form a loop at an end of the wire rope, a variety of wire rope clamps are available. A common form of a wire rope clamp is a u-bolt and saddle combination. This type of clamp generally includes a u-bolt member of circular cross section having two parallel spaced apart threaded legs. A separate saddle member has openings to receive the legs is provided to straddle the two legs. The saddle is urged closer to the “U” end of the u-bolt member by tightening two nuts onto the threaded legs.

The common clamps use of two nuts to couple the clamp to the wire rope can present a number of problems. For instance, the tightened nuts can loosen over time allowing the saddle and u-bolt to become separated whereby the wire rope sections could become separated. In addition, the nuts are freely accessible to vandals and can be removed, which could lead to safety and theft issues. Also, the tightened nuts can be freely removed by crew members wishing to remove the wires for convenience, despite removal being in contradiction to security and regulatory procedures.

### SUMMARY

The present disclosure addresses the foregoing problems by providing systems and methods that lockably coupled the wire clamp to the wire rope for security and/or safety reasons, among others.

In one general aspect, some example embodiments described by the present disclosure are directed to systems and methods for lockably securing a wire rope clamp to a section of wire rope. According to these various example embodiments, the system may have a locking clamp system, having a u-bolt with a first threaded end and a second threaded end. A saddle having a first saddle bore is configured to receive the first threaded end and a second saddle bore is configured to receive the second threaded end. A first lockable nut having a first threaded bore is configured to engage the first threaded end. The first lockable nut has a first transverse bore configured to receive a locking shaft. The first threaded bore defines a first threaded bore central axis and the first transverse bore defines a first transverse bore central axis. A second lockable nut has a second threaded bore configured to engage the second threaded end. The second lockable nut has a second transverse bore configured to receive the locking shaft. The second first threaded bore defines a second threaded bore central axis and the second transverse bore defines a second transverse bore central axis.

One embodiment includes a locking clamp system where the first threaded bore central axis is normal to the first transverse bore central axis and where the second threaded bore central axis is normal to the second transverse bore central axis. In another embodiment, the system further has a first hexagonal nut configured to engage the first threaded end intermediate the saddle. Also, the first lockable nut and a second hexagonal nut are configured to engage the second threaded end intermediate the saddle and the second lockable nut.

In another embodiment, the height of the first lockable nut is selected from a range of about 1.5 inches to 2 inches. The height of the second lockable nut is selected from a range of about 1.5 inches to 2 inches. In yet another embodiment, the width of the first lockable nut is selected from a range of about 0.5 inches to 0.75 inches. The width of the second lockable nut is selected from a range of about 0.5 inches to 0.75 inches.

In another embodiment, the system further has a wire rope clamped in a passageway between the u-bolt and the saddle.

In one embodiment, at least one of the first and second lockable nuts has a first wing and a second wing. A first transverse bore passes through one of the first and second wings. In another embodiment, the threaded bore of the first lockable nut extends the length of the first lockable nut and the threaded bore of the second lockable nut extends the length of the second lockable nut.

In yet another embodiment, the system further has a lock having a locking shaft. In another embodiment the first lockable nut is a hexagonal nut and the second lockable nut is a hexagonal nut.

Embodiments disclosed herein also include methods of preparation for the locking clamp system by: first positioning at least two sections of a rope intermediate a u-bolt and a saddle. The u-bolt has a first threaded end extending through a first bore of the saddle and a second threaded end extending through a second bore of the saddle. Next first nut engages the first threaded end extending through the first bore. The first threaded end has a first portion extending distally from the first nut Next a second nut engages the second threaded end extending through the second bore. The second threaded end has a second portion extending distally from the second nut; The saddle is biased towards the at least two sections of rope. A first lockable nut engages the first portion of the first threaded end. The first lockable nut has a first transverse bore. A second lockable nut engages the second portion of the second threaded end. The second lockable nut has a second transverse bore. By rotating at least one of the first and second lockable nuts the first transverse bore and the second transverse bore are aligned. A shackle of a lock is positioned in the first transverse bore and the second transverse bore and the shackle of the lock is locked.

Another embodiment includes the method of preparing the locking clamp system with a wire rope. In yet another embodiment, the method further includes attaching a second u-bolt and a second saddle to the rope.

Embodiments disclosed herein also include a nut having a first nut face at a first end and second nut face at a second end. An elongate shaft is interposed between the first nut face and the second nut face where the elongate shaft has a longitudinal axis. Also included is a threaded bore extending at least partially through the elongate shaft substantially parallel to the longitudinal axis. Finally a transverse passage extends through the elongate shaft transverse to the longitudinal axis where the bore is sized to receive a locking shaft.

In another embodiment, the nut further has a first transverse bore and a second transverse bore. In this embodiment, the nut is a hexagonal nut and the elongate shaft has a first face and a second face each extending along the longitudinal axis. The first transverse bore passes through the first face and the second transverse bore passes through the second face. In yet another embodiment, the nut further has a transverse passage having the first and second transverse bores where the first and second transverse bores extend along a transverse bore central axis.

In another embodiment, the nut has a cylindrical cross-section. In another embodiment the threaded bore extends through the first nut face and the second nut face along the length of the elongate shaft parallel to the longitudinal axis. In yet another embodiment, a radius of the transverse passage is selected from a range of about 0.125 inches to about 0.5 inches. In another embodiment, the length of the elongate shaft is selected from a range of about 1.5 inches to 2 inches. The width of the first nut face and the second nut face is selected from a range of about 0.5 inches to 0.75 inches.

### BRIEF DESCRIPTION OF THE DRAWINGS

The novel features of the described embodiments are set forth with particularity in the appended claims. The described example embodiments, however, both as to organization and methods of operation, may be best understood by reference to the following description, taken in conjunction with the accompanying drawings in which:

FIG. 1 is a top view of a lockable nut in accordance with one non-limiting embodiment.

FIG. 2 is a side view of the lockable nut in accordance with one non-limiting embodiment.

FIG. 3 is a cross-sectional view of the lockable nut shown in FIG. 1 taken along the section line 3-3.

FIG. 4 is a top view of a lockable nut in accordance with one non-limiting embodiment.

FIG. 5 is a cross-sectional view of the lockable nut shown in FIG. 4 taken along the section line 5-5.

FIG. 6 is a perspective view of the lockable nut shown in FIGS. 1-3.

FIG. 7 is a perspective view of a cylindrical lockable nut in accordance with one non-limiting embodiment

FIG. 8 is a perspective view of a lockable nut in accordance with one non-limiting embodiment.

FIG. 9 illustrates a partial cross-sectional view of a wire rope clamp locking system in accordance with one non-limiting embodiment.

FIG. 10 illustrates a partial cross-sectional view of a wire rope clamp locking system in accordance with another non-limiting embodiment.

FIG. 11 illustrates the use of a wire clamp locking system to secure a wire rope in accordance with one non-limiting embodiment.

FIG. 12 illustrates one embodiment of a wire rope clamp locking systems in a construction site environment.

FIG. 13 is a flow chart of a process for using a wire rope clamp locking system in accordance with one non-limiting embodiment.

### DESCRIPTION OF EXAMPLE EMBODIMENTS

As used in this patent, the term “wire rope” is intended to be used in a broad sense to include any type of rope, line, or cable. The term includes, without limitation, insulated and bare ropes, lines, and cables, and is intended to include both the singular and the plural. The term includes, but not is limited to, braided wire rope or cable, single strand rope or wire, coaxial cable, and various other types of ropes, lines and cables.

In accordance with the systems and methods described herein, a lockable nut may be coupled to the threaded legs to secure the two nuts to the threaded legs. A locking shaft can be extended through a bore in each lockable nut. When the locking shaft is in place, the lockable nuts can not be rotated. The wire rope clamp cannot be removed unless the locking shaft is first removed from the lockable nuts. Thus, the wire clamp can be lockably coupled to the wire rope for security and/or safety reasons, for example.

It is to be understood that the figures and descriptions of the following example embodiments have been simplified to illustrate elements that are relevant for a clear understanding of the present disclosure, while eliminating, for purposes of clarity, other elements. Those of ordinary skill in the art will recognize that the various elements not illustrated or described are well known in the art, and because they do not facilitate a better understanding of the present disclosure, a discussion of such elements is not provided herein. It will be further appreciated that for conciseness and clarity, spatial terms such as “vertical,” “horizontal,” “proximal,” distal,” “up,” and “down” may be used herein with respect to the drawings. However, the embodiments disclosed herein may be used in many orientations and positions, and these terms are not intended to be limiting and absolute. In addition, the figures are not necessarily drawn to precise scale.

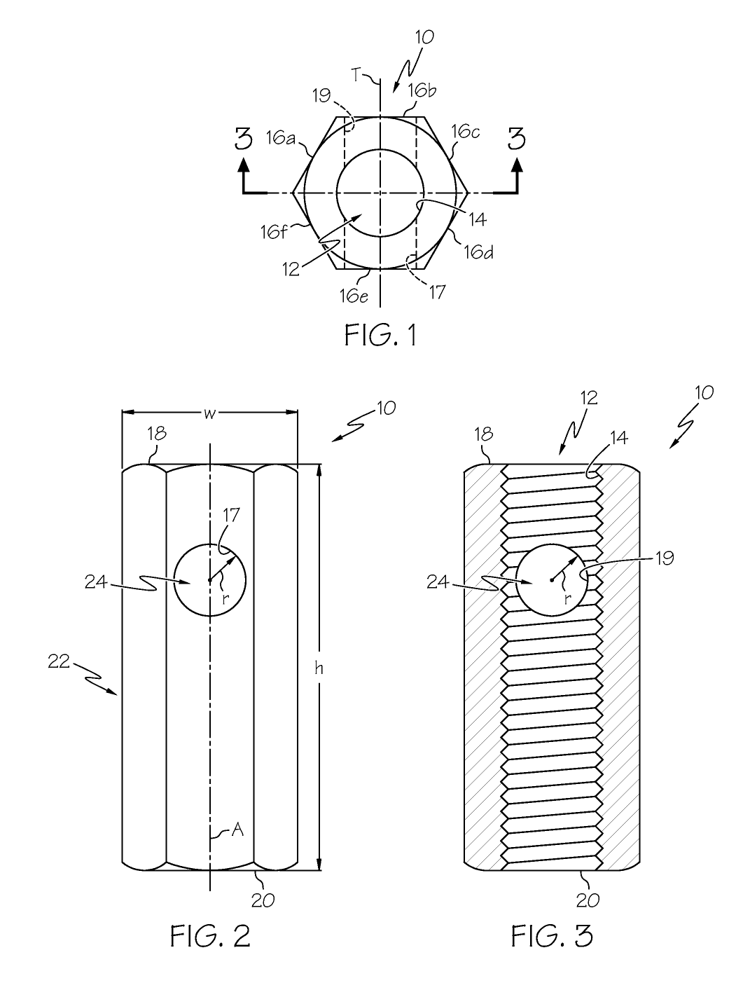

FIG. 1 is a top view of a lockable nut 10 in accordance with one non-limiting embodiment. The lockable nut 10 may have a central bore 12 having a threaded wall 14. As illustrated, the lockable nut 10 may have multiple faces (generally) 16 configured to engage a tool, such as a crescent wrench. In one embodiment, the lockable nut 10 is a hexagonal nut comprising six faces 16a, 16b, 16c, 16d, 16e and 16f. The face 16e defines a first transverse bore 17 and the face 16b, which is laterally opposed to the face 16e, defines a second transverse bore 19. The transverse bores 17, 19 may generally extend along a transverse bore central axis (illustrated as “T”) to form a transverse passage 24 (FIG. 2) through the width of the lockable nut 10.

FIG. 2 is a side view of the lockable nut 10 shown in FIG. 1. In one example embodiment, the lockable nut 10 may have an elongate shaft 22 interposed between a top face 18 and a bottom face 20. The height of the lockable nut 10 (illustrated as “h”) may be any suitable dimension. In one example embodiment, the height is in the range of about 1 inches to about 3 inches. In one example embodiment, the height is in the range of about 1.5 inches to about 2 inches. Similarly, the width of the lockable nut 10 (illustrated as “w”) may be any suitable dimension. In one example embodiment, the width is in the range of about 0.25 inches to about 1.0 inches. In one example embodiment, the width is in the range of about 0.5 inches to about 0.75 inches. The lockable nut 10 may have a longitudinal axis (illustrated as “A”) parallel to the central bore 12. In some embodiments, the longitudinal axis A may be slightly offset relative to the central bore 12 while still being substantially parallel. A transverse passage 24, defined by the first transverse bore 17 and second transverse bore 19, extends laterally through the lockable nut 10. The transverse passage 24 may extend through the lockable nut 10 at any angle. For example, the transverse passage 24 may extend through the lockable nut 10 in a direction generally normal to the longitudinal axis A. In one example embodiment, the transverse passage 24 extends through the lockable nut 10 at an oblique angle relative to the longitudinal axis A.

In one example embodiment, a radius (illustrated as “r”) of the transverse passage 24 may be, for example, in the range of about 0.125 inches to about 0.5 inches. In one example embodiment, the radius of the transverse passage 24 may be in the range of about 0.25 inches to about 0.3125 inches. Although the transverse bores 17, 19 are illustrated with circular cross-sections, other cross-sectional configurations may be used, such a slotted configuration (e.g., an elongated opening). The vertical positioning of the transverse passage 24 in relation to the top face 18 and the bottom face 20 may vary. In one embodiment, the transverse passage 24 is positioned closer to the top face 18 than the bottom face 20. Furthermore, as is to be appreciated, while a single transverse passage 24 is illustrated, the lockable nut 10 may have a plurality of transverse passages 24.

FIG. 3 is a cross-sectional view of the lockable nut 10 shown in FIG. 1 taken along the section line 3-3. The second transverse bore 19 may intersect the central bore 12. In one example embodiment, the second transverse bore 19 is generally perpendicularly to the central bore 12, while in other embodiments the second transverse bore 19 may obliquely intersect the central bore 12. In the illustrated example embodiment, the transverse passage 24 has a radius smaller than the central bore 12. This disclosure, however, is not so limited to such configurations. In some example embodiments, the radius of the transverse passage 24 may be substantially equal to or larger than the radius of the central bore 12.

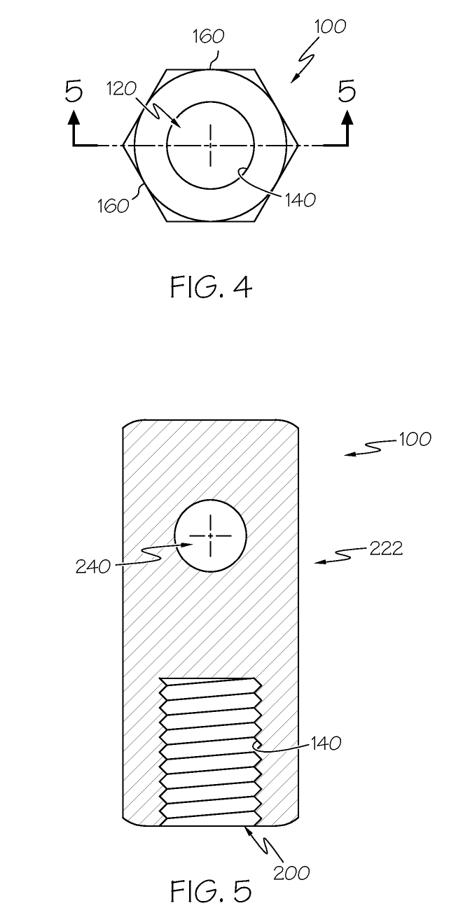

FIG. 4 is a top view of a lockable nut 100 in accordance with one non-limiting embodiment. The lockable nut 100 may have a central bore 120 having a threaded wall 140. The central bore 120 may be a blind hole such that it does not extend the entire longitudinal length of the lockable nut 100. The lockable nut 100 may have a plurality of faces 160.

FIG. 5 is a cross-sectional view of the lockable nut 100 shown in FIG. 4 taken along the section line 5-5. The central bore 120 partially extends into a body 222 of the lockable nut 100. The depth of the central bore 120 may be any suitable depth. In the illustrated embodiment, a transverse bore 240 extends through the body 222 such that it does not intersect the central bore 120.

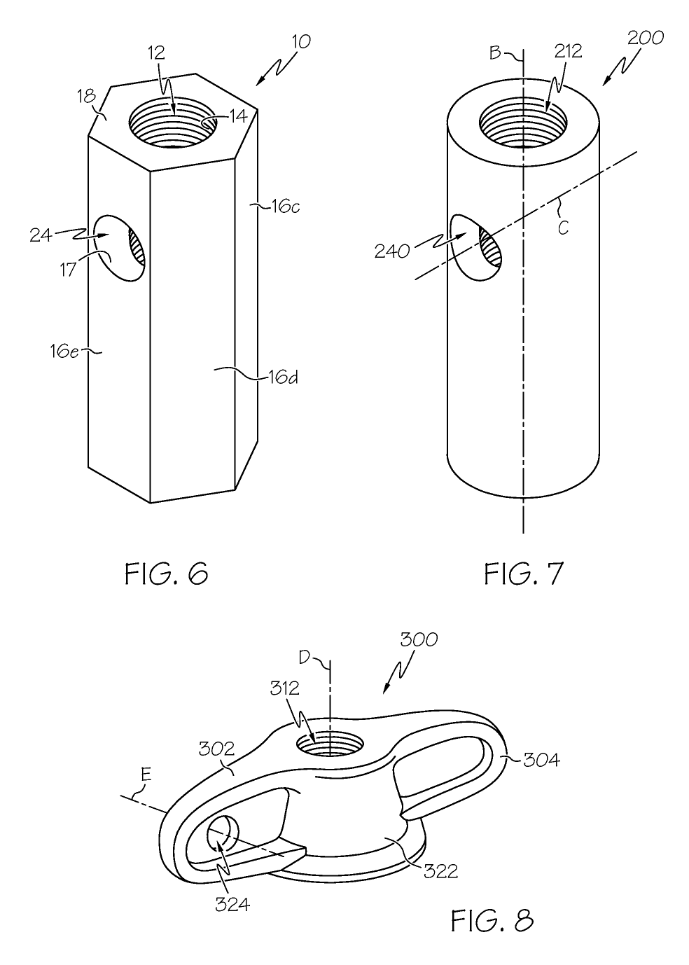

FIGS. 6-8 are perspective views of various embodiments of lockable nuts. FIG. 6 is a perspective view of the hexagonal lockable nut 10 of FIGS. 1-3. The presently disclosed embodiments are not limited to hexagonal lockable nuts; FIG. 7, for example, illustrates a cylindrical lockable nut 200 in accordance with one non-limiting embodiment. The lockable nut 200 defines a central bore 212 extending substantially parallel to a longitudinal axis (illustrated as “B”). The central bore 212 extends the entire length of the lockable nut 200. In some embodiments, the central bore 212 is a blind hole that only partially extends into the length of the lockable nut 200. The lockable nut 200 also defines a transverse passage 240 that extends through the lockable nut 200 along a transverse bore central axis (illustrated as “C”). In the illustrated example embodiment, the transverse bore central axis C is generally normal to the longitudinal axis B. In other embodiments, the transverse bore central axis C may be oblique to the longitudinal axis B. While lockable nuts having hexagonal and circular cross-sections are illustrated, it is to be appreciated that other cross-sectional shapes may be used, such as square, for example. Furthermore, the lockable nut may have a variety of cross-sectional shapes at various positions along the longitudinal axis. The cross-sectional shape of a first portion may be hexagonal while the cross-sectional shape of a second portion may be circular, rectangular, or square, for example.

FIG. 8 is a perspective view of a lockable nut 300 in accordance with one non-limiting embodiment. The lockable nut 300 is a wing nut having a first wing 302 and a second wing 304. The lockable nut 300 defines a threaded bore 312 extending through the lockable nut 300 substantially parallel to a threaded bore central axis (illustrated as “D”). The first wing 302 defines a transverse bore 324. The transverse bore extends through the lockable nut 300 along a transverse bore central axis (illustrated as “E”). In some embodiments, the second wing 304 will also define a transverse bore. In some embodiments, the central portion 322 will define a transverse bore that extends through the lockable nut 300 and intersects the central bore 312.

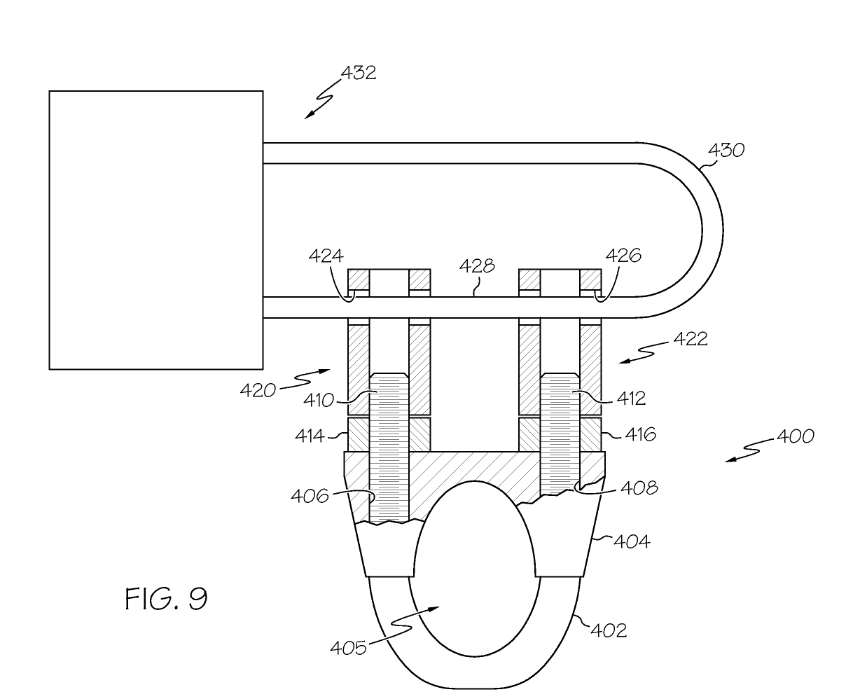

FIG. 9 illustrates a partial cross-sectional view of a wire rope clamp locking system 400 in accordance with one non-limiting embodiment. The system 400 includes a u-bolt 402 and a saddle 404. The saddle 404 defines a first bore 406 and a second bore 408 each for receiving a first threaded end 410 and a second threaded end 412 of the u-bolt 402. When the saddle 404 is coupled to the u-bolt 402, a passageway 405 is defined intermediate the saddle 404 and the u-bolt 402. As discussed in more detail below, sections of a wire rope may be passed through the passageway 405 and secured between the saddle 404 and the u-bolt 402. The system may also include a first nut 414 and a second nut 416. Once the first threaded end 410 is passed through the first bore 406, the first nut 414 is threaded onto the first threaded end 410. Similarly, once the second threaded end 412 is passed through the second bore 408, the second nut 416 is threaded onto the second threaded end 412. A first lockable nut 420 is threaded onto the first threaded end 410 and a second lockable nut 422 is threaded onto the second threaded end 412. In this embodiment, the first and second lockable nuts 420, 422 are similar to the lockable nut 10 in FIGS. 1-3. In some embodiments, the first and second nuts 414, 416 are not used as part of the system and instead the first and second lockable nuts 420, 422 are tightened against the saddle 404.

The first lockable nut 420 includes at least one transverse bore 424 and the second lockable nut 422 includes at least on transverse bore 426. Through rotation of the first and second lockable nuts 420, 422 the transverse bores 424, 426 are positioned in substantial alignment. Once substantially aligned, a locking shaft 428 is passed through the transverse bores 424, 426. In one embodiment, the locking shaft 428 is a portion of a shackle 430 of a lock 432. The transverse bores 424, 426 are sized to accommodate the locking shaft 428.

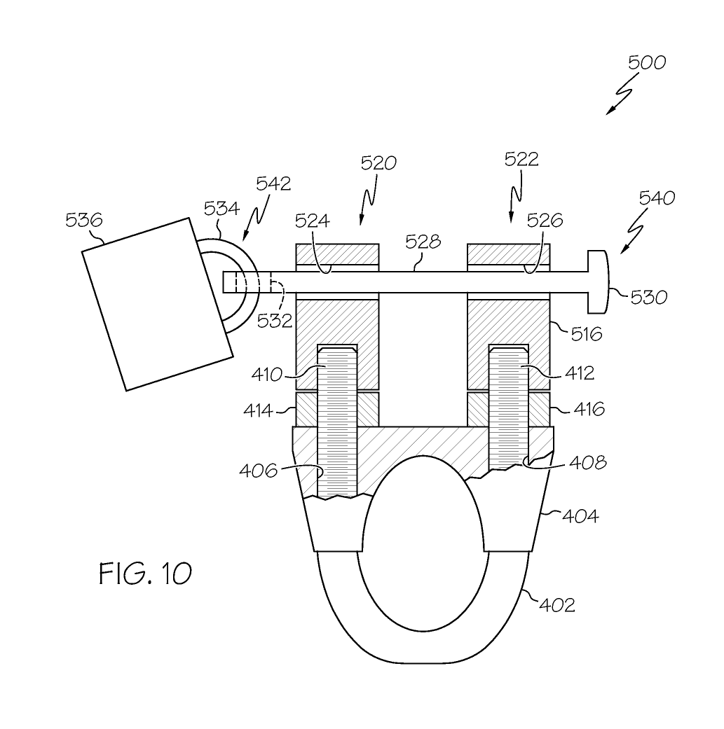

FIG. 10 illustrates a partial cross-sectional view of a wire rope clamp locking system 500 in accordance with another non-limiting embodiment. As illustrated, the u-bolt 402 and saddle 404 configuration is similar to FIG. 10. In this example embodiment, a first lockable nut 520 is threaded onto the first threaded end 410 and a second lockable nut 522 is threaded onto the second threaded end 412. In this example embodiment, the first and second lockable nuts 520, 522 are similar to the lockable nut 100 in FIGS. 4-5, although other configurations may be used. A locking shaft 528 may be passed through the transverse bores 524, 526 in the first and second lockable nuts 520, 522, respectively. The locking shaft 528 may have an enlarged head 530 at a first end 547 that engages a face 516 of the second lockable nut 522. The locking shaft 528 defines a bore 532 at a second end 542. The bore 532 may receive, for example, a shackle 534 of a lock 536.

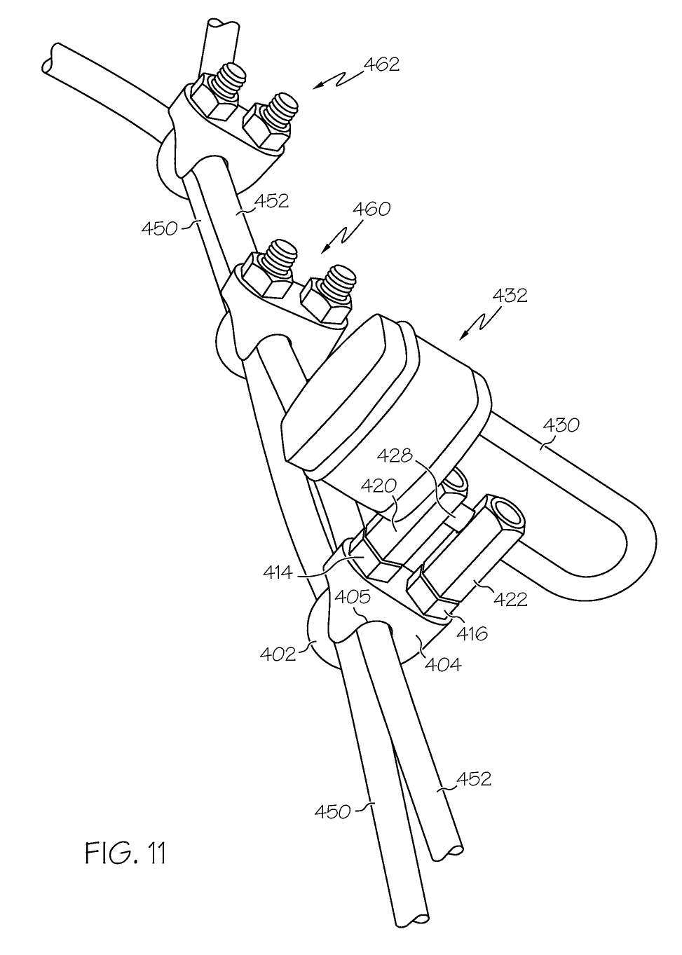

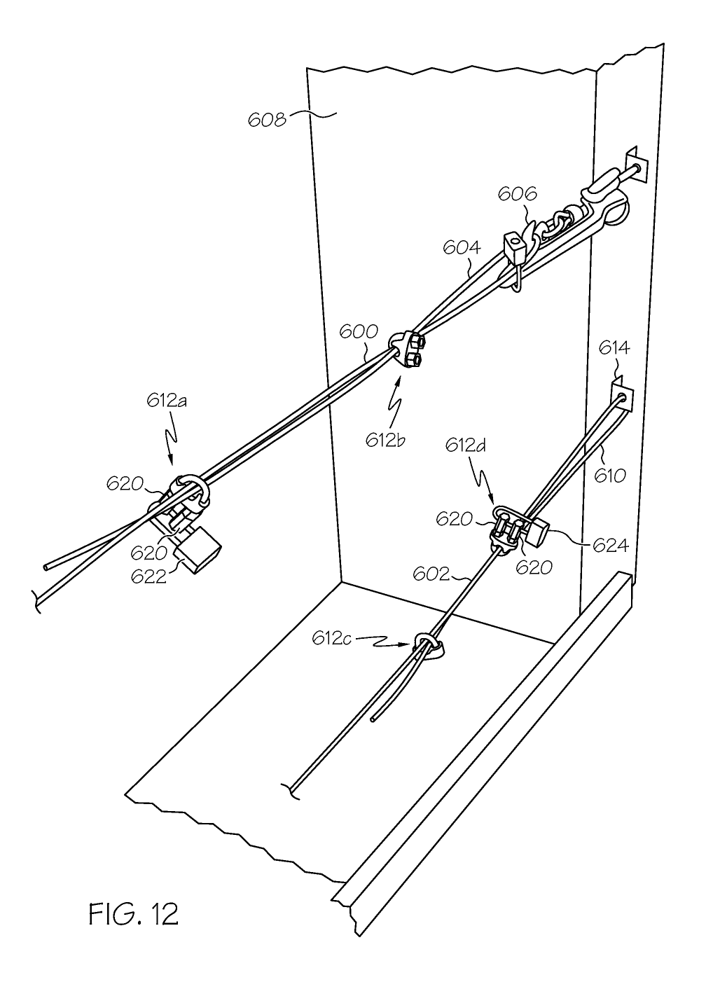

FIG. 11 illustrates the use of a wire clamp locking system securing a wire rope in accordance with one non-limiting embodiment. In FIG. 11, the wire rope clamp locking system 400 of FIG. 9 is illustrated. It is to be appreciated, however, that other example embodiments of wire rope clamp locking systems may be used to secure wire rope. A first wire rope portion 450 and a second wire rope portion 452 are positioned and clamped in the passageway 405 defined by the saddle 404 and the u-bolt 402. The first nut 414 and the second nut 416 are tightened against the saddle 404 to apply a biasing force to the first and second wire rope portions 450, 452 against the u-bolt 402. The locking shaft 428 impedes rotation of the first and second lockable nuts 420, 422. The first and second nuts 414, 416 can not be removed without first removing the locking shaft 428. Thus, the wire clamp locking system 400 will secure the first and second portions of wire rope 450, 452 until the lock 432 is removed. As illustrated, in various embodiments, additional wire rope clamps may be secured to the wire rope portions. For example, a first wire clamp 460 and a second wire clamp 462 may be secured to the first and second wire rope portions 450, 452. As is to be appreciated, the number and size of the wire rope clamps used for a particular application will vary based at least on the size of the wire rope and the amount of tension applied to the wire rope. A set of lockable nuts may be applied to one or more of the wire rope clamps for security and/or safety reasons.

FIG. 12 illustrates one embodiment of a wire rope clamp locking systems in a construction site environment. A first wire rope 600 and a second wire rope 602 may be drawn across an opening. The opening may, for example, pose a fall hazard at a construction site. The wire ropes 600, 602 serve as temporary railings until the opening is closed during the construction process. A first loop 604 in the first wire rope 600 is fed through a first connector 606 secured to a wall 608. Similarly, a second loop 610 in the second wire rope 612 is fed through a second connector 614 secured to the wall 608. Wire rope clamps 612m, where m is any positive integer, are secured to the wire ropes 600, 602. In the illustrated embodiment, wire rope clamps 612a, 612b are coupled to the first wire rope 600 and wire rope clamps 612c, 612d are coupled to the second wire rope 602. Wire rope clamps 612a, 612d each include a pair of lockable nuts 620. A first lock 622 is engaged to the pair of lockable nuts 620 coupled to the wire rope clamp 612a and a second lock 624 is engaged to the pair of lockable nuts 620 coupled to the wire rope clamp 612d.

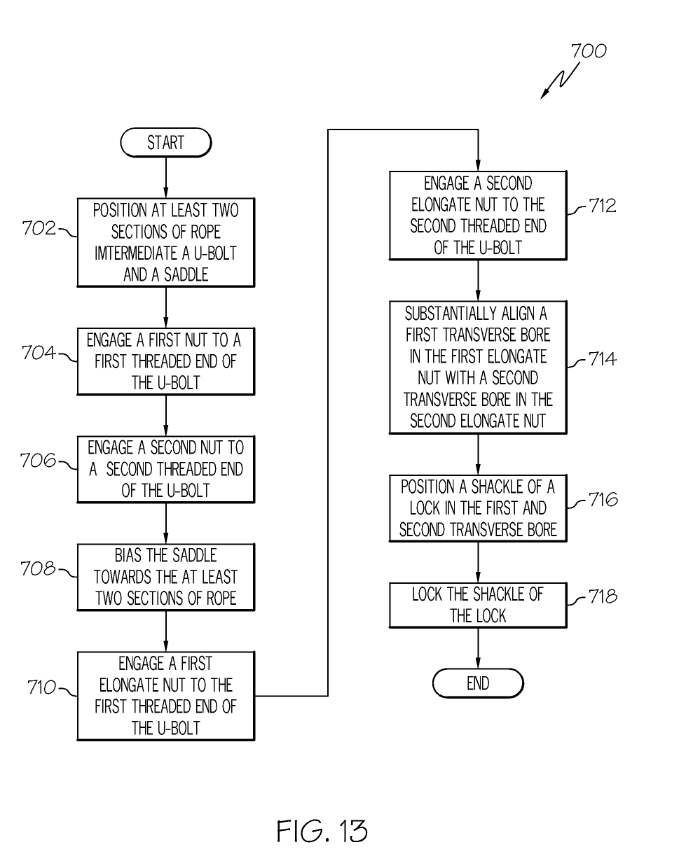

FIG. 13 is a flow chart 700 of a process for using a wire rope clamp locking system in accordance with one non-limiting embodiment. At 702, at least two sections of a rope are positioned intermediate a u-bolt and a saddle of a wire rope clamp. In one example embodiment, the rope is a wire rope. The u-bolt includes a first threaded end extending through a first bore of the saddle and a second threaded end extending through a second bore of the saddle. At 704, a first nut is engaged to the first threaded end extending through the first bore. Once the first nut is engaged, a first portion of the first threaded end extends distally from the first nut. At 706, a second nut is engaged to the second threaded end extending through the second bore. Once the second nut is engaged, a second portion of the second threaded end extends distally from the second nut. At 708, the saddle is biased towards the at least two sections of rope. To bias the saddle, in one example embodiment, the first and second nuts may be tightened against the saddle. At 710, a first lockable nut is engaged to the first portion of the first threaded end. The first lockable nut includes a first transverse bore. At 712, a second lockable nut is engaged to the second portion of the second threaded end. The second lockable nut may include a second transverse bore. At 714, at least one of the first and second lockable nuts is rotated to substantially align the first transverse bore and the second transverse bore. At 716, a shackle of a lock is positioned in the first transverse bore and a second transverse bore. At 718, the shackled of the lock is locked. In one embodiment, a second u-bolt and a second saddle are attached to the rope.

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense. Furthermore, any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment. As is to be appreciated, the systems and methods described herein are applicable in any cabling or rigging application where release of a wire rope could lead to undesirable results, such as safety or security issues. Example environments include, for example, construction environments, industrial environments, amusement park environments, marine environments, aircraft environments, airfield environments, and theater environments.

1. A locking clamp system, comprising:
a u-bolt comprising a first threaded end and a second threaded end;
a saddle comprising a first saddle bore configured to receive the first threaded end and a second saddle bore configured to receive the second threaded end;
a first lockable nut comprising a first threaded bore configured to engage the first threaded end, wherein the first lockable nut comprises a first transverse bore configured to receive a locking shaft, wherein the first threaded bore defines a first threaded bore central axis and the first transverse bore defines a first transverse bore central axis; and
a second lockable nut comprising a second threaded bore configured to engage the second threaded end, wherein the second lockable nut comprises a second transverse bore configured to receive the locking shaft, wherein second first threaded bore defines a second threaded bore central axis and the second transverse bore defines a second transverse bore central axis.

2. The locking clamp system of claim 1, wherein the first threaded bore central axis is normal to the first transverse bore central axis; and wherein the second threaded bore central axis is normal to the second transverse bore central axis.

3. The locking clamp system of claim 1, further comprising:
a first hexagonal nut configured to engage the first threaded end intermediate the saddle and the first lockable nut; and
a second hexagonal nut configured to engage the second threaded end intermediate the saddle and the second lockable nut.

4. The locking clamp system of claim 1, wherein the height of the first lockable nut is selected from a range of about 1.5 inches to 2 inches, and wherein the height of the second lockable nut is selected from a range of about 1.5 inches to 2 inches.

5. The locking clamp system of claim 1, wherein the width of the first lockable nut is selected from a range of about 0.5 inches to 0.75 inches, and wherein the width of the second lockable nut is selected from a range of about 0.5 inches to 0.75 inches.

6. The locking clamp system of claim 1, further comprising a wire rope clamped in a passageway defined by the u-bolt and the saddle.

7. The locking clamp system of claim 1, wherein at least one of the first and second lockable nuts comprises a first wing and a second wing, wherein the first transverse bore passes through one of the first and second wings.

8. The locking clamp system of claim 1, wherein the threaded bore of the first lockable nut extends the length of the first lockable nut, and wherein the threaded bore of the second lockable nut extends the length of the second lockable nut.

9. The locking clamp system of claim 1, further comprising a lock comprising the locking shaft.

10. The locking clamp system of claim 1, wherein the first lockable nut is a hexagonal nut and the second lockable nut is a hexagonal nut.

11. A method, comprising:
positioning at least two sections of a rope intermediate a u-bolt and a saddle, wherein the u-bolt comprises a first threaded end extending through a first bore of the saddle and a second threaded end extending through a second bore of the saddle;
engaging a first nut to the first threaded end extending through the first bore, wherein the first threaded end comprises a first portion extending distally from the first nut;
engaging a second nut to the second threaded end extending through the second bore, wherein the second threaded end comprises a second portion extending distally from the second nut;
biasing the saddle towards the at least two sections of rope;
engaging a first lockable nut to the first portion of the first threaded end, wherein the first lockable nut comprises a first transverse bore;
engaging a second lockable nut to the second portion of the second threaded end, wherein the second lockable nut comprises a second transverse bore;
rotating at least one of the first and second lockable nuts to align the first transverse bore and the second transverse bore;
positioning a shackle of a lock in the first transverse bore and the second transverse bore; and
locking the shackle of the lock.

12. The method of claim 11, wherein the rope is a wire rope.

13. The method of claim 11, further comprising:
attaching a second u-bolt and a second saddle to the rope.

14-20. (canceled)
